(19) United States
(12) Patent Application Publication
(10) Pub. No.: US 2025/0274683 A1
(43) Pub. Date: Aug. 28, 2025

(54) IMAGE SENSOR, DEVICE INCLUDING THE SAME, AND OPERATING METHOD OF THE IMAGE SENSOR

(71) Applicant: SAMSUNG ELECTRONICS CO., LTD., Suwon-si (KR)

(72) Inventors: Daehee BAE, Suwon-si (KR); Minwoong SEO, Suwon-si (KR); Sanggwon LEE, Suwon-si (KR); Masamichi ITO, Suwon-si (KR)

(73) Assignee: SAMSUNG ELECTRONICS CO., LTD., Suwon-si (KR)

(21) Appl. No.: 18/986,210

(22) Filed: Dec. 18, 2024

(30) Foreign Application Priority Data
Feb. 28, 2024 (KR) 10-2024-0029231

(51) Int. Cl. H04N 25/78; H04N 25/532; H04N 25/57; H04N 25/76

(52) U.S. Cl. CPC H04N 25/78; H04N 25/532; H04N 25/57; H04N 25/7795

(57) ABSTRACT

An image sensor configured to operate in a global shutter mode includes a pixel array including a plurality of pixels, a timing controller configured to control a cycle of an output signal corresponding to each of N pieces of frame data output from the plurality of pixels, and (N-1) frame buffers configured to store (N-1) pieces of frame data, respectively.

### CROSS-REFERENCE TO RELATED APPLICATION

This application is based on and claims priority under 35 U.S.C. § 119 to Korean Patent Application No. 10-2024-0029231, filed on Feb. 28, 2024, in the Korean Intellectual Property Office, the disclosure of which is incorporated by reference in its entirety.

### BACKGROUND

The disclosure relates to an image sensor, a device including the image sensor, and an operating method of the image sensor. Particularly, the disclosure relates to an image sensor including a frame buffer.

An image sensor is a device that captures a two-dimensional or three-dimensional image of an object. An image sensor may generate an image of an object by using a photoelectric conversion device that reacts according to the intensity of light reflected from the object. Recently, with the development of computer and communication industries, the demand for image sensors with improved performance has increased in various electronic devices, such as digital cameras, camcorders, a personal communication system (PCS), gaming devices, security cameras, medical micro cameras, and mobile phones.

The image sensor may generate high dynamic range (HDR) images by receiving photocharges corresponding to a plurality of exposure times and generating image data of high or low brightness. A frame buffer may be required to store multiple types of frame data to generate an HDR image.

### SUMMARY

One or more example embodiments of the disclosure provide an image sensor that may reduce the usage amount of a frame buffer.

According to an aspect of an example embodiment of the disclosure, an image sensor is provided.

The image sensor may operate in a global shutter mode and include a pixel array including a plurality of pixels, a timing controller configured to control a cycle of an output signal corresponding to each of N pieces of frame data, corresponding to a first frame to an N^{th} frame, output from the plurality of pixels, and (N-1) frame buffers configured to store (N-1) pieces of frame data, respectively.

According to another aspect of an example embodiment of the disclosure, a device including an image sensor is provided.

The image device includes an image sensor configured to read out N pieces of frame data corresponding to a first frame to an N^{th} frame that are consecutive, and an image signal processor configured to merge and process the N pieces of frame data, wherein the image sensor may be configured to operate in a global shutter mode, and wherein the image sensor may be configured to differently control a readout speed of at least one piece of frame data among readout speeds of the N pieces of frame data.

According to another aspect of an example embodiment of the disclosure, an operating method of an image sensor is provided.

The operating method may include outputting N pieces of frame data corresponding to a first frame to an N^{th} frame from an image sensor, storing (N-1) pieces of frame data among the N pieces of frame data in a frame buffer, and storing, in a line buffer, at least a portion of the N pieces of frame data not stored in the frame buffer.

### BRIEF DESCRIPTION OF DRAWINGS

Example embodiments of the disclosure will be more clearly understood from the following detailed description taken in conjunction with the accompanying drawings in which:

FIG. 1 is a block diagram illustrating a schematic configuration of an image sensor according to an example embodiment;

FIG. 2 is a block diagram illustrating an image sensor according to another example embodiment;

FIG. 3 is a diagram illustrating an operation of a global shutter mode of an image sensor according to an example embodiment;

FIG. 4A is a diagram illustrating an image signal processor (ISP) processing of a plurality of frames, according to a comparative example;

FIG. 4B is a diagram illustrating an ISP processing of a plurality of frames, according to an example embodiment;

FIG. 5 is a diagram illustrating an operating method of an image sensor, according to an example embodiment;

FIG. 6 is a flowchart illustrating an operating method of an image sensor, according to an example embodiment;

FIG. 7 is a flowchart illustrating an operating method of an image sensor, according to an example embodiment;

FIG. 8A is a diagram illustrating analog-to-digital converter (ADC) output data, readout data from a frame buffer, and ISP output data according to a comparative example;

FIG. 8B is a diagram illustrating ADC output data, readout data from a frame buffer, and ISP output data according to an example embodiment;

FIG. 9 is a diagram illustrating a signal corresponding to ADC output data and a signal for reading out the ADC output data according to an example embodiment; and

FIG. 10 is a diagram illustrating a signal corresponding to ADC output data and a signal for reading out the ADC output data according to an example embodiment corresponding to components of the disclosure.

### DETAILED DESCRIPTION

Hereinafter, various example embodiments are described with reference to the attached drawings.

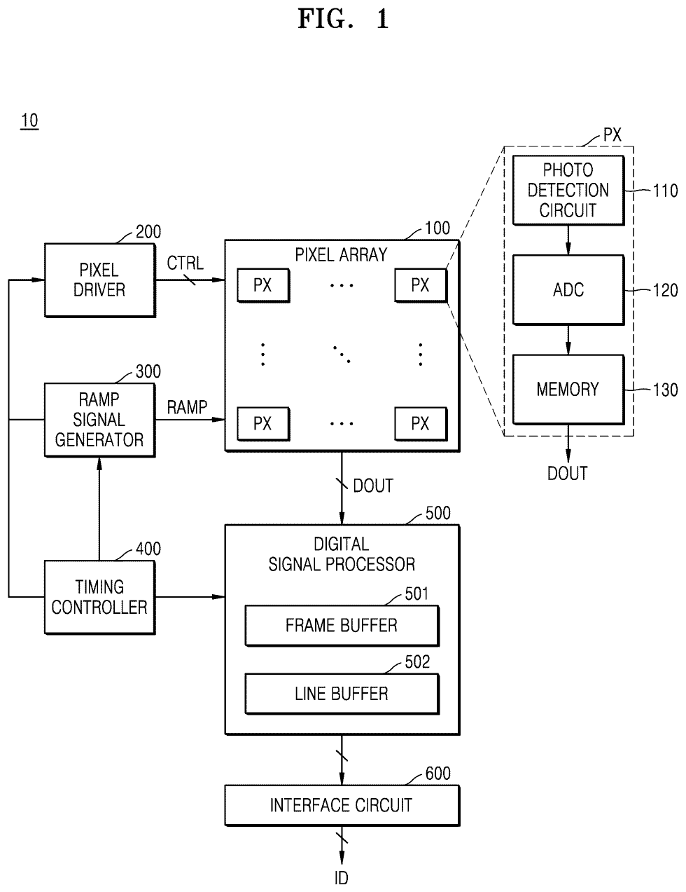

FIG. 1 is a block diagram illustrating a schematic configuration of an image sensor according to an example embodiment.

A pixel PX illustrated in FIG. 1 may be a digital pixel that may perform a global shutter function.

An image sensor 10 may be mounted on an electronic device having an image or light sensing function. For example, the image sensor 10 may be mounted on an electronic device, such as a camera, a smartphone, a wearable device, an Internet of Things (IoT) device, a tablet personal computer (PC), a personal digital assistant (PDA), a portable multimedia player (PMP), or a navigation device. Also, the image sensor 10 may be mounted on an electronic device included, as a component, in a vehicle, furniture, a manufacturing facility, a door, and various measurement devices.

The image sensor 10 may include a pixel array 100, a pixel driver (a row driver) 200, a ramp signal generator 300, a timing controller 400, a digital signal processor 500, and an interface circuit 600. The pixel array 100 may include a plurality of pixels PX, and each of the plurality of pixels PX may detect an optical signal from the outside and output a digital output signal DOUT corresponding to the detected optical signal.

The plurality of pixels PX may detect an optical signal by using an optical sensing element and convert the optical signal into the digital output signal DOUT, which is an electrical signal. Each of the plurality of pixels PX may detect light in a certain spectrum range. For example, the plurality of pixels PX may include a red pixel that converts light in a red spectrum range into an electrical signal, a green pixel that converts light in a green spectrum range into an electrical signal, and a blue pixel that converts light in a blue spectrum range into an electrical signal. A color filter may be placed on or above each of the plurality of pixels PX to transmit light in a certain spectrum range therethrough, and a micro lens for condensing light may be placed on or above the color filter and the plurality of pixels PX.

The pixel PX may include a photo detection circuit 110, an analog-to-digital converter (hereinafter, referred to as an ADC) 120, and a memory 130. In some embodiments, the pixel array 100 may include a first semiconductor substrate and a second semiconductor substrate that are stacked on each other. For example, the photo detection circuit 110 of the pixel PX may be provided on the first semiconductor substrate, and the ADC 120 that converts a signal generated by the photo detection circuit 110 into a digital signal may be provided on the second semiconductor substrate that is different from the first semiconductor substrate. Photo detection circuits 110 provided on the first semiconductor substrate may each be connected to ADCs 120 provided on the second semiconductor substrate through an electrical connection member, to transmit a detection signal to the ADCs 120. In some embodiments, the electrical connection member may include a through silicon via (TSV) penetrating the first semiconductor substrate and/or a metal-to-metal connection structure formed respectively on the first semiconductor substrate and the second semiconductor substrate. In some embodiments, the memory 130 may be provided on the second semiconductor substrate. The photo detection circuit 110 may include a photo-sensing device and convert an optical signal detected from the outside into an electrical signal, that is, a detection signal which is an analog signal. For example, the photo-sensing device may include a photodiode, a phototransistor, a port gate, or a pinned photodiode. The detection signal may include a detection signal according to a reset operation of the pixel PX and may include a detection signal according to a light detection operation of the pixel PX.

The ADC 120 may convert the detection signal output from the photo detection circuit 110 into a digital signal. In some embodiments, the ADC 120 may convert the detection signal into a digital signal by comparing the detection signal with a ramp signal RAMP. The memory 130 may store the digital signal. The memory 130 may output a digital output signal DOUT to the digital signal processor 500.

The pixel driver 200 may output a control signal CTRL for controlling the plurality of pixels PX included in the pixel array 100. In response to the control signal CTRL generated by the pixel driver 200, each of the plurality of pixels PX may generate a detection signal, convert the detection signal into a digital signal by using a ramp signal RAMP, store the digital signal, and output the stored digital signal as the digital output signal DOUT.

The ramp signal generator 300 may generate the ramp signal RAMP and output the ramp signal RAMP to the pixel array 100. The ramp signal RAMP may be provided to the pixel array 100 (for example, the ADC 120 of the pixel PX) and may be used as a reference signal, which is to be compared with the detection signal. In one embodiment, the ramp signal RAMP may be a signal that steadily decreases or increases (for example, an increase or decrease signal with a single and/or linear slope).

The timing controller 400 may control all operations of the image sensor 10. For example, the timing controller 400 may control operation timing of the image sensor 10 based on control information received from an external device (for example, an image signal processor (ISP), an application processor (AP), or so on) through the interface circuit 600. The pixel driver 200 and the ramp signal generator 300 may respectively generate the control signal CTRL and the ramp signal RAMP based on timing signals provided from the timing controller 400.

According to one embodiment, the digital output signal DOUT output from the pixel array 100 may be output as frame data corresponding to a number that is set by the image sensor 10. According to one embodiment, when the number set by the image sensor 10 is N, the pixel array 100 may output N pieces of frame data. The timing controller 400 according to the disclosure may control an output speed of frame data output from the pixel array 100. The timing controller 400 may control the output speed of a last frame data among N pieces of frame data output from the pixel array 100 such that the last frame data is output more slowly than the other pieces of frame data. More detailed operations of the timing controller 400 are described below.

The digital signal processor 500 may perform digital signal processing on the digital output signal DOUT received from the pixel array 100 and provide final image data ID to an external device. The digital output signal DOUT may include a reset value according to a reset operation of the pixel PX and may include an image signal value according to a light detection operation of the pixel PX.

The digital signal processor 500 may determine a final digital value corresponding to the optical signal detected by one of the plurality of pixels PX by performing arithmetic on the reset value and the image signal value of the one of the plurality of pixels PX. The final image data ID may be generated by combining final digital values determined by the plurality of pixels PX. That is, a correlated double sampling operation may be performed according to the digital output signal DOUT generated by the digital signal processing operation of the digital signal processor 500 and an operation of the ADC 120 included in the pixel PX.

The digital signal processor 500 may include frame buffers 501. According to one embodiment, a number of frame buffers 501 included in the digital signal processor 500 may be different from a number of pieces of frame data processed by the image sensor 10. When the number of pieces of frame data processed by the image sensor 10 is N, the number of frame buffers 501 included in the digital signal processor 500 may be N-1. N may be a natural number of 2 or more.

The digital signal processor 500 may include a line buffer 502. A size of the line buffer 502 may be smaller than a size of one of the frame buffers 501. The line buffer 502 may store line data corresponding to some lines of the last frame data among a plurality of pieces of frame data.

According to the disclosure, in order to reduce a size of a buffer required when processing the frame buffer, image data of the last frame may be output to have a variable size of 1h (one horizontal time). According to the disclosure, a frame per second (FPS) may be improved by reducing a time required to store an N^{th} frame in a buffer.

The interface circuit 600 may receive control information from an external device or output the final image data ID. In an embodiment, the interface circuit 600 may exchange the above-described information with an external device based on a preset protocol.

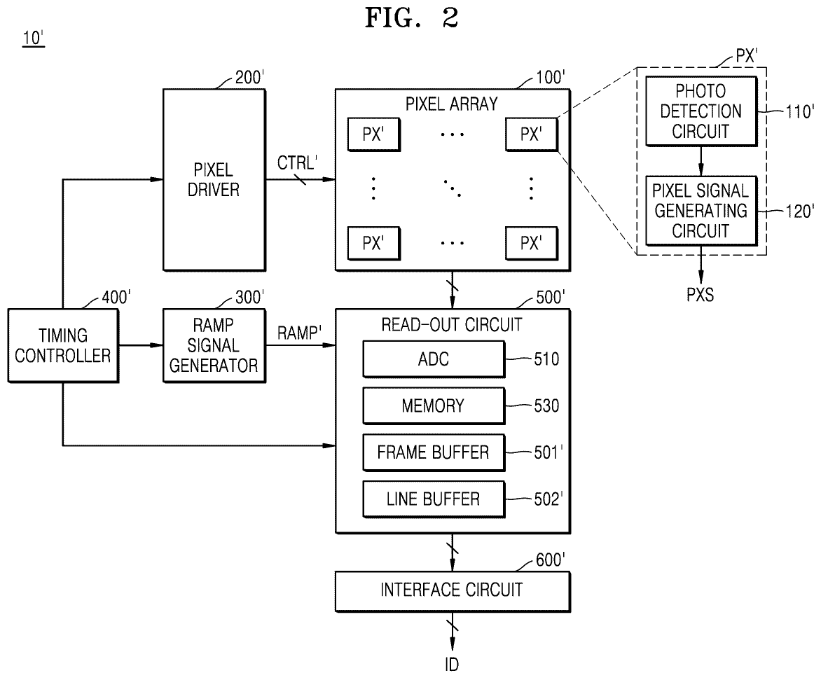

FIG. 2 is a block diagram illustrating an image sensor according to another example embodiment.

A pixel PX' illustrated in FIG. 2 may be a digital pixel that may perform a global shutter operation. Compared to the image sensor 10 of FIG. 1, an image sensor 10′ of FIG. 2 does not include an ADC 510 inside a pixel PX' but may include the ADC 510 outside a pixel array 100′. In describing the image sensor illustrated in FIG. 2, redundant descriptions of the same symbols as in FIG. 1 are omitted.

Referring to FIG. 2, the image sensor 10′ may include the pixel array 100′, a pixel driver 200′, a ramp signal generator 300′, a timing controller 400′, a read-out circuit 500′, and an interface circuit 600′. The pixel array 100′ may include a plurality of pixels PX', each of the plurality of pixels PX' may detect an optical signal from the outside and output a pixel signal PXS corresponding to a detected optical signal.

The plurality of pixels PX' of the pixel array 100′ may be arranged in a matrix in which a plurality of rows and a plurality of columns are arranged. In a global shutter mode, the image sensor 10′ may control photo-charge accumulation time points of the plurality of pixels PX' arranged in different rows to be identical and thus remove image distortion that may be caused by a difference between the photo-charge accumulation time points of the plurality of pixels PX' arranged in different rows.

The plurality of pixels PX' may each include a photo detection circuit 110′ and a pixel signal generating circuit 120′. The photo detection circuit 110′ may include a photo sensing element and convert an optical signal detected from the outside into an electrical signal, that is, a detection signal which is an analog signal. The detection signal may include a detection signal according to a reset operation of the photo detection circuit 110′ and may include a detection signal according to a light detection operation of the photo detection circuit 110′.

The pixel signal generating circuit 120′ may receive the detection signal, generate a pixel signal PXS corresponding to the detection signal, and output the pixel signal PXS through a column line.

The pixel driver 200′ may output a control signal CTRL' for controlling the plurality of pixels PX' included in the pixel array 100′. The plurality of pixels PX' may respectively operate in a plurality of operation modes according to illuminance in response to the control signal CTRL' generated by the pixel driver 200′. In an embodiment, the pixel driver 200′ may determine a timing at which the control signal CTRL' output to each of the plurality of pixels PX' is activated or deactivated to operate in a global shutter mode.

The ramp signal generator 300′ may generate a ramp signal RAMP' and provide the ramp signal RAMP' to the read-out circuit 500′, for example, the ADC 510. The ramp signal RAMP' may be a signal for converting an analog signal into a digital signal and may be generated to have a shape of a triangle wave.

The read-out circuit 500′ may include the ADC 510, a memory 530, a frame buffer 501′, and a line buffer 502′. The ADC 510 may sample and hold the pixel signal PXS received from the pixel array 100′ and perform a correlated double sampling operation by double sampling a reset signal and an image signal and outputting a level corresponding to a difference therebetween. The ADC 510 may receive the ramp signal RAMP', compare the reset signal and the image signal with the ramp signal RAMP', and output a comparison result signal.

The ADC 510 may convert the comparison result signal into a digital signal. The memory 530 may latch the digital signal and sequentially output latched image data ID. The frame buffer 501′ may store N-1 pieces of frame data among the N pieces of frame data, and the line buffer 502′ may store line data that is some of the frame data which is not stored in the frame buffer among the N pieces of frame data.

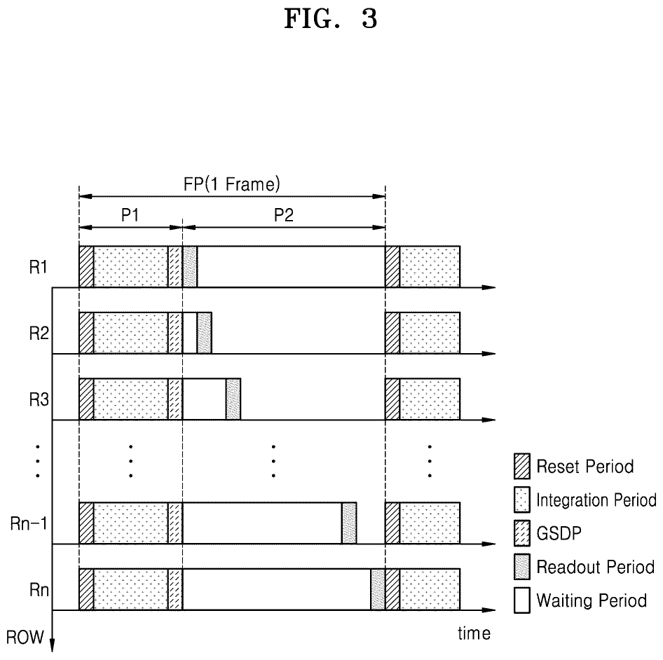

FIG. 3 is a diagram illustrating the operation of a global shutter mode of an image sensor according to an example embodiment.

Referring to FIGS. 1 and 2, the image sensor 100 may operate in a global shutter mode.

One frame period FP may include a first period P1 and a second period P2, and the plurality of pixels PX of the pixel array 110, that is, a plurality of rows (for example, a first row R1 to an n^{th} row Rn) of the pixel array 110, may simultaneously perform a reset operation, an exposure operation, and a global signal dumping operation in the first period P1, and the plurality of rows of the pixel array 110 may sequentially perform a read operation in the second period P2. The second period P2 may be referred to as a frame readout period.

The first period P1 may include a reset period, an integration period, and a global signal dumping period (GSDP), and the plurality of pixels PX may perform the reset operation for removing charges accumulated in a photodiode (and a floating diffusion node) during the reset period, perform an accumulation operation in which a photodiode generates and accumulates photocharges corresponding to a received optical signal during the integration period, and store a reset signal according to a reset level of the floating diffusion node and an image signal corresponding to the photocharges accumulated in the photodiode during the GSDP respectively in at least two capacitors provided in each of the plurality of pixels PX.

In the second period P2, a rolling readout operation, in which a readout operation performed during a readout period is sequentially performed for each row, may be performed. For example, after the readout operation is performed on a first row R1 of the pixel array 110, a readout operation on a second row R2 may be performed in a next order. In addition, after the readout operation for the second row R2 is performed, a readout operation on a third row R3 may be performed in a next order. During the readout operation, the reset signal and the image signal stored respectively in at least two capacitors during the GSDP may be output from each of the plurality of pixels PX as pixel signals.

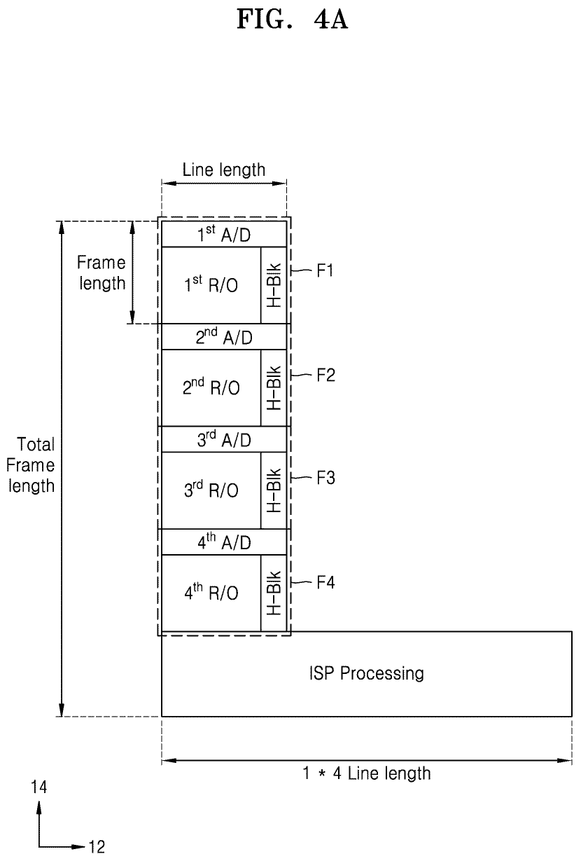

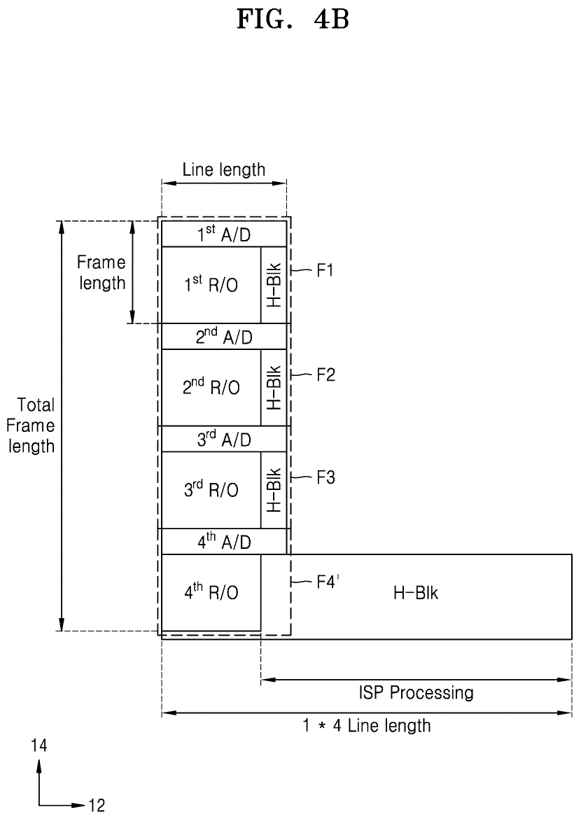

FIG. 4A is a diagram illustrating an ISP processing of a plurality of frames, according to a comparative example.

Referring to FIG. 4A, regions corresponding to a first frame F1, a second frame F2, a third frame F3, and a fourth frame F4 are displayed, and a diagram illustrates that image signal processing is performed by using the first frame F1 to the fourth frame F4.

Referring to FIG. 4A, a length of the first frame F1 in a first direction 12 may be a line length. A length of the first frame F1 in the first direction 12 may be a length corresponding to a total number of lines included in the first frame F1. A length of the first frame F1 in a second direction 14 may be a frame length.

Referring to FIG. 4A, the first frame F1 may include a first conversion region 1^{st} A/D, a horizontal blank region H-Blk, and a first readout region 1^{st} R/O. According to one embodiment, the first conversion region 1^{st} A/D may be a region corresponding to a section in which data corresponding to the first frame F1 is converted from analog data to digital data. The first readout region 1^{st} R/O may be a region corresponding to a section in which data corresponding to the first frame F1 converted into digital data is read out. The horizontal blank region H-Blk may be a region corresponding to a section in which analog-to-digital conversion for a next frame line is prepared.

The second frame F2 may include a second conversion region 2^{nd} A/D, another horizontal blank region H-Blk, and a second readout region 2^{nd} R/O. The third frame F3 may include a third conversion region 3^{rd} A/D, another horizontal blank region H-Blk, and a third readout region 3^{rd} R/O. The fourth frame F4 may include a fourth conversion region 4^{th} A/D, another horizontal blank region H-Blk, and a fourth readout region 4^{th} R/O. The second conversion region to the fourth conversion region, horizontal blank regions, and the second readout region to the fourth readout region respectively included in the second frame F2 to the fourth frame F4 may have the same or similar configurations as the first conversion region, the horizontal blank region, and the first readout region included in the first frame F1, and accordingly, redundant descriptions thereof are omitted.

Referring to FIG. 4A, in the comparative example, an ISP processing is performed after analog-to-digital conversions of the first frame F1, the second frame F2, the third frame F3, and the fourth frame F4 are completed and readout of all pieces of converted data is completed. Accordingly, a total frame length may be calculated by adding frame lengths corresponding to four frames to a length of a frame in which ISP processing is performed.

In order to complete the analog-to-digital conversions of the first frame F1, the second frame F2, the third frame F3, and the fourth frame F4, four frame buffers for respectively storing the first frame F1, the second frame F2, the third frame F3, and the fourth frame F4 may be required. Referring to FIG. 4A, in order for an image sensor including digital pixels including multiple ADCs to process each piece of frame data, all frames first need to be output from the multiple analog-to-digital converters. Also, when multiple frames are processed, A/D regions of the multiple frames may be different from each other, and accordingly, frame buffers corresponding to the multiple frames may be required. When a frame buffer is used, a significant amount of cost is required in terms of digital logic, and when the number of frame buffers increases, a chip size may also increase, and thus, costs and power consumption may increase. Therefore, it may be desirable to provide a readout method of an image sensor that may reduce use of a frame buffer.

FIG. 4B is a diagram illustrating ISP processing of a plurality of frames, according to an example embodiment.

Referring to FIG. 4B, regions respectively corresponding to the first frame F1, the second frame F2, the third frame F3, and a fourth frame F4′ are illustrated. The first frame F1, the second frame F2, and the third frame F3 may be the same or similar to the first to third frames described with reference to FIG. 4A, and thus, redundant descriptions thereof are omitted.

Referring to FIG. 4B, the fourth frame F4′ may include a fourth conversion region 4^{th} A/D, a fourth readout region 4^{th} R/O, and a vertical blank region H-Blk. Referring to FIG. 4B, a length of the vertical blank region H-Blk included in the fourth frame F4′ may have a value greater than lengths of the vertical blank regions H-blk included in the first frame F1, the second frame F2, and the third frame F3.

Referring to FIG. 4B, the first frame F1, the second frame F2, and the third frame F3 may be sequentially read out, and frame data corresponding to respective frames may be stored in respective frame buffers. After the fourth conversion region 4^{th} A/D is completed, the fourth frame F4′ may be read out in real time without being stored in the frame buffer. In this case, frame data corresponding to the fourth frame F4′ may be read out line by line, and data corresponding thereto may be stored in the line buffer. By adjusting a readout time of the frame data corresponding to the fourth frame F4′, respective lines of the first frame F1, the second frame F2, the third frame F3, and the fourth frame F4′ may be sequentially read out and synthesized with each other.

When comparing FIG. 4A with FIG. 4B, the total frame length according to FIG. 4B may be shorter than the total frame length according to FIG. 4A. The disclosure provides an image sensor that may reduce a use amount of a frame buffer while synthesizing a large number of frames. More detailed embodiments of the disclosure are described below.

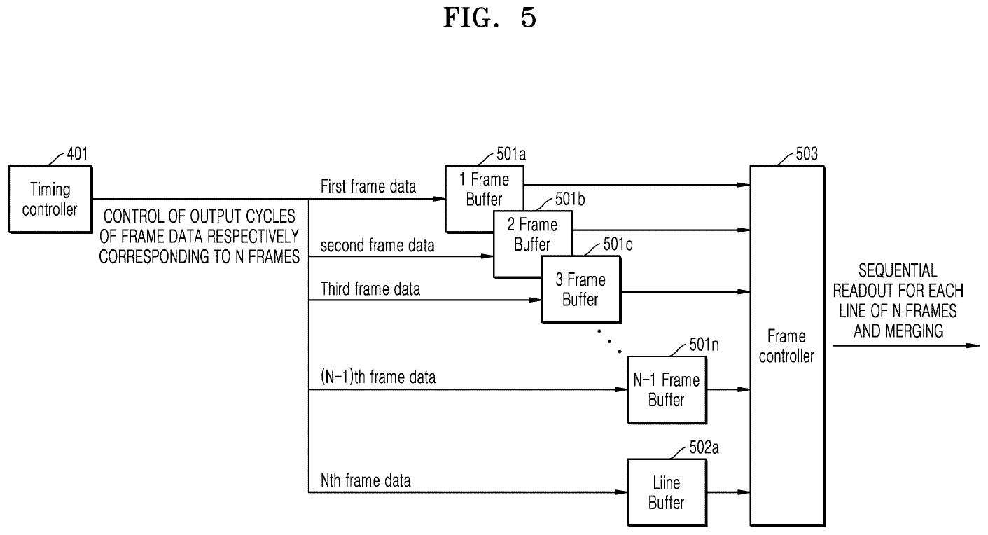

FIG. 5 is a diagram illustrating an operating method of an image sensor, according to an example embodiment.

A timing controller 401 of FIG. 5 may correspond to the timing controller 400 illustrated in FIG. 1 and the timing controller 400′ illustrated in FIG. 2. First, second, third, . . . (N-1)^{th} frame buffers 501a, 501b, 501c, . . . and 501n of FIG. 5 may correspond to the frame buffer 501 illustrated in FIG. 1 and the frame buffer 501′ illustrated in FIG. 2. A line buffer 502a of FIG. 5 may correspond to the line buffer 502 illustrated in FIG. 1 and the line buffer 502′ illustrated in FIG. 2.

Referring to FIG. 5, the timing controller 401 may control an output cycle of frame data corresponding to each of a plurality of frames. According to one embodiment, the timing controller 401 may differently control an output period of frame data corresponding to each of N frames. The timing controller 401 may control an output cycle of N^{th} frame data among frame data corresponding to N frames to be different from output cycles of other frame data.

According to one embodiment, first frame data, second frame data, third frame data, . . . , n^{th} frame data may be determined according to a sequence of frame data that are sequentially output. According to one embodiment, the first frame data may indicate frame data that is output first, and N^{th} frame data may indicate frame data that is output last.

According to one embodiment, the first frame data may be stored in the first frame buffer 501a. The second frame data may be stored in the second frame buffer 501b. The third frame data may be stored in the third frame buffer 501c. The N-1^{th} frame data may be stored in the N-1^{th} frame buffer 501n. The N^{th} frame data may be stored in the line buffer 502a.

According to one embodiment, output cycles of the first frame data, the second frame data, the third frame data, . . . , the N^{th} frame data may be controlled by the timing controller 401.

According to the disclosure, by controlling the output period of the N^{th} frame data to be slower than the output period of the other frame data, partially output pieces of N^{th} frame data may be stored in the line buffer 502a and be read out in real time, and thus, usage amounts of frame buffers may be reduced.

According to one embodiment, a frame controller 503 may be connected to the first frame buffer, . . . , the (N-1)^{th} frame buffer 501a, . . . , 501n and the line buffer 502a. According to one embodiment, the frame controller 503 may be included in the frame buffer 501. The frame controller 503 may sequentially read out the data stored in the first frame buffer, . . . , to (N-1)^{th} frame buffer 501a, . . . , 501n and the line buffer 502a for each line. The data sequentially read out for each line may be merged by an ISP. According to one embodiment, the ISP may perform high dynamic range (HDR) synthesis. The HDR synthesis may be technology for increasing a dynamic range by synthesizing multiple frames with different brightness at a similar time point into one frame.

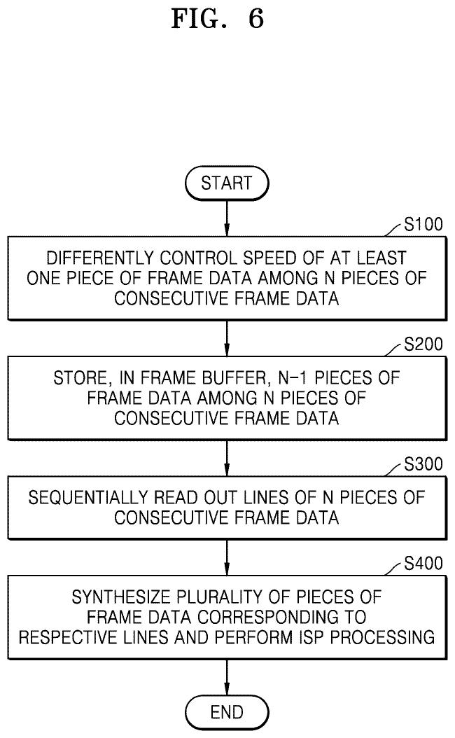

FIG. 6 is a flowchart illustrating an operating method of an image sensor, according to an example embodiment.

Referring to operation S100 of FIG. 6, the timing controller may differently control a speed of at least one piece of frame data among N pieces of consecutive frame data, that is, to be different from that of other pieces of the frame data. In this case, the speed of frame data may be a readout speed of data corresponding to each frame. In the disclosure, differently controlling the speed of at least one piece of the frame data may refer to differently controlling an output cycle of a signal corresponding to at least one piece of the frame data.

Referring to operation S200 of FIG. 6, N-1 pieces of frame data among the N pieces of consecutive frame data may be stored in a frame buffer. Accordingly, when N pieces of frame data is read out, the image sensor may include N-1 frame buffers. According to one embodiment, N-1 pieces of frame data among N pieces of consecutive frame data may be stored in each frame buffer, and some of the other pieces of frame data may be stored in a line buffer.

Referring to operation S300 of FIG. 6, lines of the N pieces of consecutive frame data may be sequentially read out. According to one embodiment, line data corresponding to one line of the N pieces of consecutive frame data may be read out sequentially.

Referring to operation S400 of FIG. 6, ISP processing may be performed by synthesizing a plurality of pieces of frame data corresponding to respective lines. According to one embodiment, there may be N pieces of line data corresponding to the first line of the N pieces of consecutive frame data. By synthesizing N pieces of first line data, first line data of the final frame may be output.

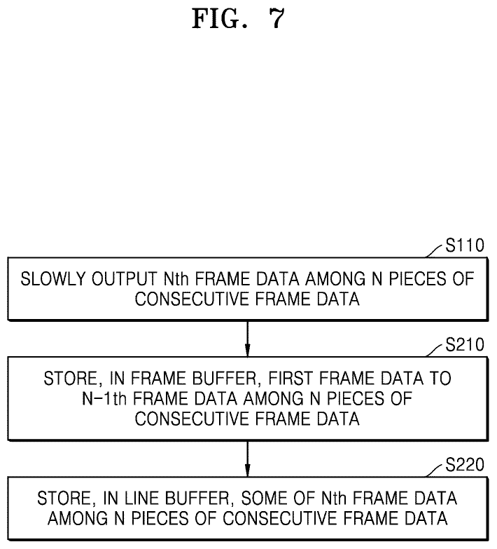

FIG. 7 is a flowchart illustrating an operating method of an image sensor, according to an example embodiment.

Operation S110 of FIG. 7 may be included in operation S100 of FIG. 6.

Operation S210 and operation S220 of FIG. 7 may be included in operation S200 of FIG. 6.

Referring to operation S110 of FIG. 7, a timing controller may slowly output the N^{th} frame data among N pieces of consecutive frame data. According to one embodiment, output speeds of the first frame data to the N-1^{th} frame data may all be equal to each other, and the output speed of the N^{th} frame data may be slower than output speeds of the first frame data to the N-1^{th} frame data.

Referring to operation S210 of FIG. 7, each of the first frame data to the N-1^{th} frame data among the N pieces of consecutive frame data may be stored in a corresponding frame buffer.

Referring to operation S220 of FIG. 7, some of the N^{th} frame data among the N pieces of consecutive frame data may be stored in a line buffer.

According to the disclosure, when synthesizing N pieces of consecutive frame data, only N-1 frame buffers may be required, and thus, a use amount of frame buffers may be reduced. With reference to the following example embodiments, output speeds of frame data and a readout method of the frame data according to the disclosure are described in more detail.

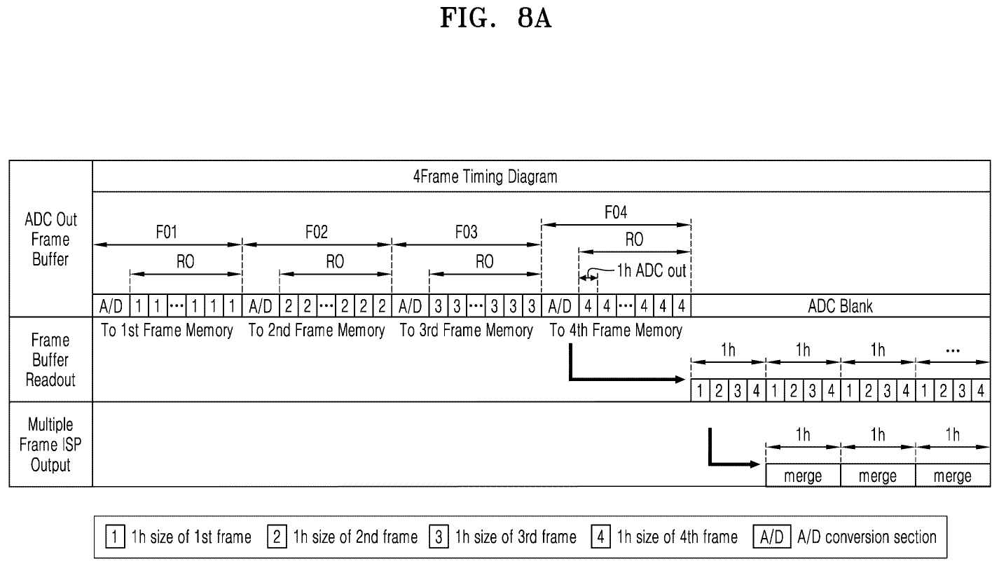

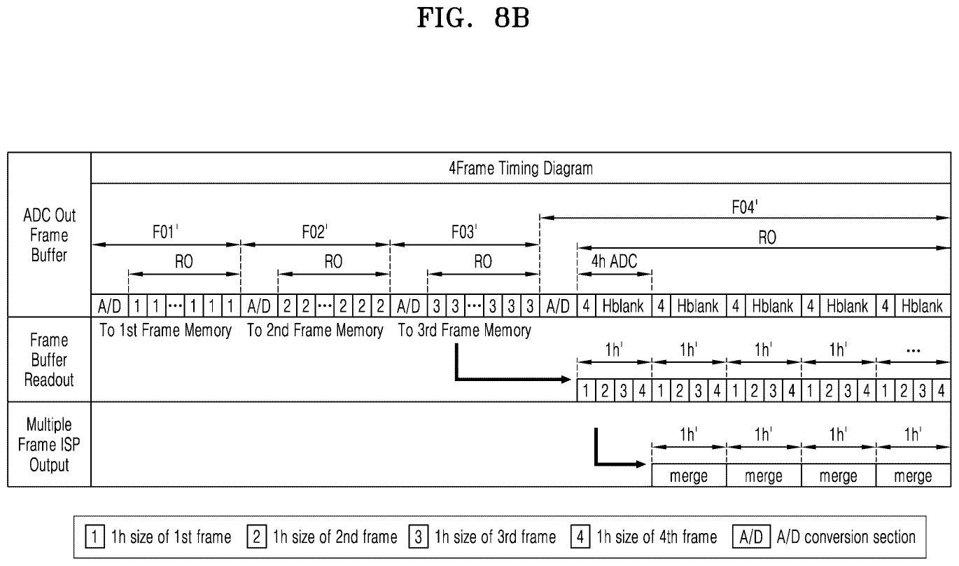

FIG. 8A is a diagram illustrating ADC output data, readout data from a frame buffer, and ISP output data according to a comparative example.

FIG. 8A illustrates that data corresponding to each frame is output from an ADC and is stored in a frame buffer (denoted as “ADC Out Frame Buffer”), readout data is output from each frame buffer (denoted as “Frame Buffer Readout”), and then ISP output data is generated (denoted as “Multiple Frame ISP Output”). An X-axis in the diagram of FIG. 8A may denote time. The comparative example of FIG. 8A illustrates performing an ISP processing when four frames are output from an image sensor by way of example.

The data corresponding to each frame output from the ADC may be sequentially output (ADC Out Frame Buffer) for each frame. An output section FO1 corresponding to the first frame, an output section FO2 corresponding to the second frame, an output section FO3 corresponding to the third frame, and an output section FO4 corresponding to the fourth frame may be sequentially output.

The output section FO1 corresponding to the first frame may include a conversion section A/D and a readout section RO. In the conversion section A/D, a signal corresponding to the first frame may be converted from an analog signal to a digital signal, and in the readout section RO, data of respective lines (denoted as 1) corresponding to the first frame may be sequentially output. The data of the respective lines 1 may be output to correspond to the number of lines included in the first frame.

The output section FO2 corresponding to the second frame may include a conversion section A/D and a readout section RO. In the conversion section A/D, a signal corresponding to the second frame may be converted from an analog signal to a digital signal, and in the readout section RO, data of respective lines (denoted as 2) corresponding to the second frame may be sequentially output. The data of the respective lines 2 may be output to correspond to the number of lines included in the second frame.

The output section FO3 corresponding to the third frame may include a conversion section A/D and a readout section RO. In the conversion section A/D, a signal corresponding to the third frame may be converted from an analog signal to a digital signal, and in the readout section RO, data of respective lines (denoted as 3) corresponding to the third frame may be sequentially output. The data of respective lines 3 may be output to correspond to the number of lines included in the third frame.

The output section FO4 corresponding to the fourth frame may include a conversion section A/D and a readout section RO. In the conversion section A/D, a signal corresponding to the fourth frame may be converted from an analog signal to a digital signal, and in the readout section RO, data of respective lines (denoted as 4) corresponding to the fourth frame may be sequentially output. The data of respective lines 4 may be output to correspond to the number of lines included in the fourth frame.

The output sections F01, F02, F03, and F04 corresponding to respective frames may be output to corresponding frame buffers and stored in the corresponding frame buffers. Accordingly, in the embodiment of FIG. 8A, four frame buffers respectively corresponding to the output sections F01, F02, F03, and F04 may be required. A size of 1 h (or one horizontal time) may be a size (or a length of time) at which line data of each line corresponding to the first to the fourth frames are output.

In the present specification, time of 1 h may be 1-horizontal time. For example, when a frame rate is Z (Z is a natural number of 2 or more), 1-horizontal time may be determined as 1/(Z*n). In this case, n may be the number of rows of the pixel array 110. 1-horizontal time may refer to the time required to perform analog-to-digital conversion of pixel signals corresponding to 1-line or pixel signals output from pixels included in one row. In the present specification, a size of 1 h may be a length in the X-axis direction corresponding to 1-horizontal time.

After data is output from the four frame buffers, the data is read out sequentially from the same lines in respective frames, and an ISP processing may be performed by merging the data of the same lines to correspond to respective lines. While readout data is output from the frame buffer (Frame Buffer Readout), line data may be read out from a buffer corresponding to each of a plurality of frames stored in the frame buffer and transmitted to ISP hardware. Referring to FIG. 8A, the first line 1 of the first frame, the first line 2 of the second frame, the first line 3 of the third frame, and the first line 4 of the fourth frame may be sequentially read out, and accordingly, data of all frames corresponding to the first line may be read out. When the data of all frames corresponding to the first line are read out, the data corresponding to the first line may be merged, and the merged image data corresponding to the first line may be output.

Referring to the comparative example of FIG. 8A, for processing by an ISP that requires a plurality of frames, data corresponding to each frame image may be stored in a frame buffer and then be processed sequentially. According to one embodiment, HDR merge may be performed by using the plurality of frames. Referring to FIG. 8A, output data corresponding to four frames may be stored in frame buffers respectively, and then lines of respective frames may be sequentially output from the frame buffers and processed.

According to a comparative example, the first frame to the fourth frame may all be output in the same size of 1 h and stored in the frame buffer. According to one embodiment, an image sensor that operates in a global shutter mode has to store all frames in a frame buffer before being used. Four frame buffers are required to store all pieces of data corresponding to the first frame to the fourth frame.

FIG. 8B is a diagram illustrating ADC output data, readout data from a frame buffer, and ISP output data according to an example embodiment.

FIG. 8B illustrates that data corresponding to each frame is output from an ADC and is stored in a frame buffer (denoted as “ADC Out Frame Buffer”), readout data is output from each frame buffer (denoted as “Frame Buffer Readout”), and then ISP output data is generated (denoted as “Multiple Frame ISP Output”). An X-axis in the diagram of FIG. 8B may denote time. In the embodiment of FIG. 8B, an ISP processing on four frames may be performed by way of example.

The data corresponding to each frame output from the ADC may be sequentially output for each frame. An output section FO1′ corresponding to the first frame, an output section FO2′ corresponding to the second frame, an output section FO3′ corresponding to the third frame, and an output section FO4′ corresponding to the fourth frame may be sequentially output.

The output section FO1′ corresponding to the first frame may include a conversion section A/D and a readout section RO. In the conversion section A/D, a signal corresponding to the first frame may be converted from an analog signal to a digital signal, and in the readout section RO, data of respective lines (denoted as 1) corresponding to the first frame may be sequentially output. The data of the respective lines 1 may be output to correspond to the number of lines included in the first frame.

The output section FO2′ corresponding to the second frame may include a conversion section A/D and a readout section RO. In the conversion section A/D, a signal corresponding to the second frame may be converted from an analog signal to a digital signal, and in the readout section RO, data of respective lines (denoted as 2) corresponding to the second frame may be sequentially output. The data of the respective lines 2 may be output to correspond to the number of lines included in the second frame.

The output section FO3′ corresponding to the third frame may include a conversion section A/D and a readout section RO. In the conversion section A/D, a signal corresponding to the third frame may be converted from an analog signal to a digital signal, and in the readout section RO, data of respective lines (denoted as 3) corresponding to the third frame may be sequentially output. The data of the respective lines 3 may be output to correspond to the number of lines included in the third frame.

The output section FO4′ corresponding to the fourth frame may include a conversion section A/D and a readout section RO. In the conversion section A/D, a signal corresponding to the fourth frame may be converted from an analog signal to a digital signal. The readout section RO may include a horizontal blank section Hblank between respective lines (denoted as 4) corresponding to the fourth frame. In the readout section RO corresponding to the fourth frame, the horizontal blank section Hblank is included between the respective lines 4, and thus, an output speed of data of the respective lines 4 corresponding to the fourth frame may be controlled to be slow. According to one embodiment, output lengths 1h′ of the respective lines 4 may be four times the size of 1 h. According to another example, the output lengths 1h′ of the respective lines 4 may exceed four times the size of 1 h. According to one embodiment, a size of 1 h may be a size (or length of time) at which each piece of line data of a line corresponding to the first frame to the third frame are output. According to one embodiment, an actual output length of line data of each line of the fourth frame may have the size of 1 h, and the horizontal blank section Hblank may be increased by 3 h such that a total size of 4 h is output for the line data of the fourth frame (that is, the total size of the line data of the fourth frame is increased by four times).

A size of one horizontal time (1 h′) of each of the lines 4 corresponding to the fourth frame may be four times the size of one horizontal time (1 h) of each of the lines 1, 2, and 3 corresponding to the first frame to the third frame. That is, by delaying the output length (or increasing the size) of one horizontal time of each of the lines 4 corresponding to the fourth frame by four times that of the data of a previous frame, only the line data necessary for reading out data from respective lines of the last frame is read out and stored in a line buffer and output shortly after, and thus, a frame buffer corresponding to the fourth frame may not be required.

Data corresponding to the first frame to the third frame may be stored in a frame buffer. The respective lines 4 corresponding to the fourth frame may be stored in a line buffer rather than the frame buffer. Output of the respective lines 4 corresponding to the fourth frame may be delayed by four times through the horizontal blank section Hblank and stored in the line buffer.

Referring to FIG. 8B, first line data corresponding to the fourth frame may be read out more slowly by four times than an output length of the first line data corresponding to the first frame to the third frame and stored in the line buffer. Accordingly, when reading out the first line data corresponding to all frames, the data corresponding to the first frame to the third frame may be output from a frame buffer, and the data corresponding to the fourth frame may be output from the line buffer, and thus, the frame buffer corresponding to the fourth frame may be not required.

The first line data corresponding to the first frame, the first line data corresponding to the second frame, the first line data corresponding to the third frame, and the first line data corresponding to the fourth frame need to be sequentially read out. First line data corresponding to all frames may be sequentially read out and transmitted to the ISP.

By way of example, the above embodiment(s) describes that, when processing four frames, the output speed of data of the line 4 corresponding to the fourth frame may be output more slowly by four times, but the disclosure is not limited thereto. According to the disclosure, when processing N frames, the output speed of line data corresponding to the N^{th} frame may be output more slowly by N times than previous frames.

In the disclosure, decreasing the output speed may be understood in the same sense as decreasing an output cycle or increasing the time of 1h.

According to the disclosure, when reading out a plurality of pieces of frame data, instead of equally applying the same size of lines corresponding to the time of 1h, a variable line size corresponding to the time of 1h may be applied. In this manner, the first frame data to the N-1^{th} frame data may be read out relatively quickly, and the N^{th} frame data may be read out relatively slowly, and thus, the N^{th} frame data may be read out without being stored in the frame buffer. According to the disclosure, the frame data corresponding to the last frame among ADC outputs of an image sensor may be controlled to be output by increasing the size of 1 h to a multiple or more corresponding to the total number of frames.

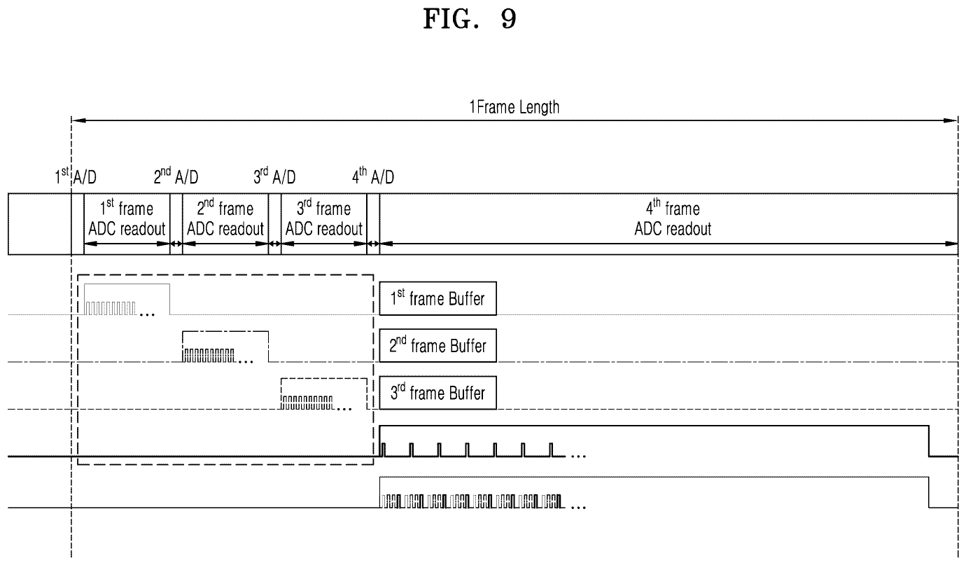

FIG. 9 is a diagram illustrating a signal corresponding to ADC output data and a signal for reading out the signal according to an example embodiment.

FIG. 9 illustrates signals for an ADC output from an image sensor that processes four frames and signals for finally merging and reading out the signals.

FIG. 9 illustrates a first conversion section 1^{st} A/D and a first frame readout section (1^{st} frame ADC readout) corresponding to the first frame, a second conversion section 2^{nd} A/D and a second frame readout section (2^{nd} frame ADC readout) corresponding to the second frame, a third conversion section 3^{rd} A/D and a third frame readout section (3^{rd} frame ADC readout) corresponding to the third frame, and a fourth conversion section 4^{th} A/D and a fourth frame readout section (4^{th} frame ADC readout) corresponding to the fourth frame.

Referring to FIG. 9, the final frame may be output by merging the first frame, the second frame, the third frame, and the fourth frame, and accordingly, a section obtained by adding all sections corresponding to the first frame, the second frame, the third frame, and the fourth frame may be a frame length (1 frame length) of the final frame.

Referring to FIG. 9, in the first frame readout section (1^{st} frame ADC readout), clock signals corresponding to a plurality of lines included in the first frame may be toggled. In the second frame readout section (2^{nd} frame ADC readout), clock signals corresponding to a plurality of lines included in the second frame may be toggled. In the third frame readout section (3^{rd} frame ADC readout), clock signals corresponding to a plurality of lines included in the third frame may be toggled. According to one embodiment, cycles of the clock signals toggled in each of the first frame readout section (1^{st} frame ADC readout), the second frame readout section (2^{nd} frame ADC readout), and the third frame readout section (3^{rd} frame ADC readout) may all be equal to each other.

According to one embodiment, line data output through the first frame readout section (1^{st} frame ADC readout) may be stored in the first frame buffer (1^{st} frame Buffer). Line data output through the second frame readout section (2^{nd} frame ADC readout) may be stored in the second frame buffer (2^{nd} frame Buffer). Line data output through the third frame readout section (3^{rd} frame ADC readout) may be stored in the third frame buffer (3^{rd} Frame buffer).

In the fourth frame readout section (4^{th} Frame ADC readout), clock signals corresponding to a plurality of lines included in the fourth frame may be toggled. According to one embodiment, the cycles of clock signals corresponding to a plurality of lines included in the first frame to the third frame may be different from the cycles of clock signals corresponding to a plurality of lines included in the fourth frame. According to one embodiment, the cycles of the clock signals corresponding to the plurality of lines included in the first frame to the third frame may be shorter or faster than the cycles of the clock signals corresponding to the plurality of lines included in the fourth frame. According to one embodiment, the cycles of the clock signals corresponding to the plurality of lines included in the first frame to the third frame may be one fourth of the cycles of the clock signals corresponding to the plurality of lines included in the fourth frame.

In this way, when sequentially reading out the first line data included in a plurality of frames, the first line data included in the first frame may be read out from the first frame buffer, the first line data included in the second frame may be read out from the second frame buffer, the first line data included in the third frame may be read out from the third frame buffer, and the first line data included in the fourth frame may be read out from the line buffer. According to the disclosure, a clock signal corresponding to each of a plurality of lines included in the last frame may be output more slowly by four times than a clock signal corresponding to each of a plurality of lines included in the first frame to the third frame, only one line data is stored in the line buffer after being output, the line data is output according to the readout timing of the plurality of pieces of line data, and thus, only one line buffer may be sufficient for readout.

According to the disclosure, when processing is performed by using a frame buffer, image data corresponding to the last frame may be output to have a variable size of a horizontal time (1h) to reduce a size of a required buffer. According to the disclosure, when using a total of N frames, N-1 frames may be stored in a buffer, and the last N^{th} frame may be slowly read out by N times the size of a horizontal time (1h) of the general frame and be transmitted to an image processing device.

According to the comparative example, a system that performs image processing with N frames requires N frame buffers, but according to the disclosure, a system that performs image processing with N frames, only N-1 frame buffers are required, and thus, a use amount of a frame buffer may be reduced.

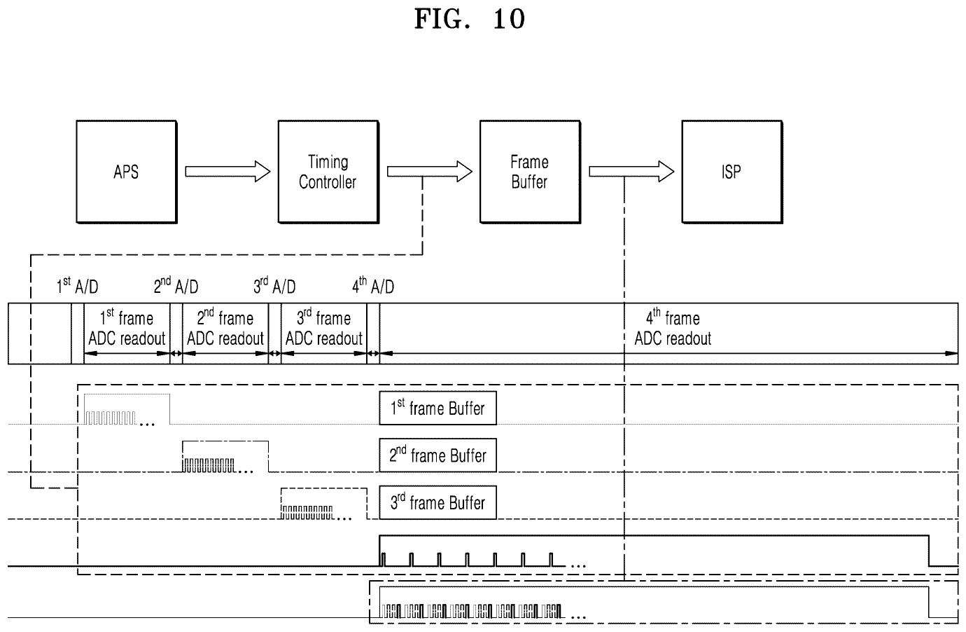

FIG. 10 is a diagram illustrating a signal corresponding to ADC output data and a signal for reading out the ADC output data according to an example embodiment corresponding to components of the disclosure.

The signal diagram in FIG. 10 may be the same as the diagram illustrated in FIG. 9. In the embodiment of FIG. 10, redundant descriptions that overlap with the descriptions made with reference to FIG. 9 may be omitted.

An active pixel sensor (APS) of FIG. 10 may have a configuration corresponding to pixels included in the pixel array 100 of FIG. 1 or the pixel array 100′ of FIG. 2. A timing controller of FIG. 10 may have a configuration corresponding to the timing controller 400 of FIG. 1 or the timing controller 400′ of FIG. 2. A frame buffer of FIG. 10 may have a configuration corresponding to the frame buffer 501 of FIG. 1 or the frame buffer 501′ of FIG. 2. An ISP in FIG. 10 may be an ISP that processes the final output image data. According to one embodiment, an image device, which includes an image sensor including a timing controller and a frame buffer and includes an ISP capable of processing data output from the image sensor, may be provided.

Referring to FIG. 10, the timing controller may control a signal output cycle in a readout section corresponding to each frame. According to one embodiment, the timing controller may control a signal output cycle in a readout section corresponding to the last frame to be different from signal output cycles in readout sections corresponding to the other frames. According to one embodiment, the timing controller may control the signal output cycle in the readout section corresponding to the last frame to be longer than the signal output cycle in the readout section corresponding to other frames. That is, a size of 1 h in the readout section corresponding to the last frame may be controlled to have a greater value than sizes of 1 h in readout sections corresponding to the other frames. According to one embodiment, the timing controller may control the N^{th} frame data to have a horizontal blank section Hblank having a size of (N-1)*1h.

Referring to FIG. 10, when outputting readout data to the ISP, a frame buffer may sequentially read out each piece of line data included in each piece of frame data. According to one embodiment, the frame buffer may read out in the order of first line data of the first frame, first line data of the second frame, first line data of the third frame, first line data of the fourth frame, second line data of the first frame, . . . By increasing the size of 1 h of the readout section corresponding to the last frame by the timing controller, only a portion data of the last frame may be stored in a line buffer and be read out from the line buffer, and thus, a use amount of a frame buffer may be reduced.

Referring to FIG. 10, the ISP may perform synthesis for each piece of line data of each frame and output final image data.

In the disclosure, embodiments in which an image sensor performs HDR merging based on the data stored in a plurality of frames are described, but the disclosure is not limited thereto. The image sensor according to the disclosure may be applied to a case where an image processing device that requires temporally continuous information requires a frame buffer.

As described above, embodiments are disclosed in the drawings and the disclosure. In the disclosure, embodiments are described by using certain terms, but this is only used for the purpose of describing the disclosure and is not used to limit the meaning or scope of the disclosure described in claims. Therefore, those skilled in the art will understand that various modifications and other equivalent embodiments may be derived therefrom. Therefore, the true technical protection scope of the disclosure should be determined by the technical idea of the attached claims.

While the disclosure has been particularly shown and described with reference to embodiments thereof, it will be understood that various changes in form and details may be made therein without departing from the spirit and scope of the following claims.

What is claimed is:

1. An image sensor configured to operate in a global shutter mode, the image sensor comprising:
a pixel array including a plurality of pixels;
a timing controller configured to control a cycle of an output signal corresponding to each of N pieces of frame data, corresponding to a first frame to an N^{th} frame, output from the plurality of pixels; and
(N-1) frame buffers configured to store (N-1) pieces of frame data, respectively.

2. The image sensor of claim 1, wherein the timing controller is further configured to differently control one of periods of output signals corresponding to the N pieces of frame data.

3. The image sensor of claim 1, wherein the timing controller is further configured to control a cycle of an output signal corresponding to data of the N^{th} frame among the N pieces of frame data to be different from cycles of output signals corresponding to data of the first frame to an (N-1)^{th} frame among the N pieces of frame data.

4. The image sensor of claim 3, wherein the timing controller is further configured to control the cycle of the output signal corresponding to the data of the N^{th} frame among the N pieces of frame data to be slower than the cycles of the output signals corresponding to the data of the first frame to the (N-1) th frame among the N pieces of frame data.

5. The image sensor of claim 3, wherein the timing controller is further configured to control the cycle of the output signal corresponding to the data of the N^{th} frame among the N pieces of frame data to be slower by at least N times than the cycles of the output signals corresponding to the data of the first frame to the (N-1)^{th} frame among the N pieces of frame data.

6. The image sensor of claim 1, wherein the (N-1) frame buffers are further configured to each store the (N-1) pieces of frame data excluding data of the N^{th} frame among the N pieces of frame data.

7. The image sensor of claim 6, further comprising a line buffer configured to store at least a portion of the data of the N^{th} frame.

8. The image sensor of claim 7, wherein the line buffer is configured to store data corresponding to one line of the data of the N^{th} frame.

9. The image sensor of claim 1, wherein the plurality of pixels include digital pixels.

10. A device comprising:
an image sensor configured to read out N pieces of frame data corresponding to a first frame to an N^{th} frame that are consecutive; and
an image signal processor configured to merge and process the N pieces of frame data,
wherein the image sensor is configured to operate in a global shutter mode, and
wherein the image sensor is configured to differently control a readout speed of at least one piece of frame data among readout speeds of the N pieces of frame data.

11. The device of claim 10, wherein the image sensor comprises:
(N-1) frame buffers configured to store (N-1) pieces of frame data among the N pieces of frame data; and
a line buffer configured to store data corresponding to a line of one piece of frame data among the N pieces of frame data.

12. The device of claim 11, wherein the image sensor is further configured to control an output cycle of the (N-1) pieces of frame data to be stored in the (N-1) frame buffers as a first cycle, and control an output cycle of frame data to be stored in the line buffer as a second cycle.

13. The device of claim 12, wherein the first cycle is faster than the second cycle.

14. The device of claim 12, wherein the first cycle is 1/N of the second cycle.

15. The device of claim 11, wherein the (N-1) frame buffers and the line buffer are configured to sequentially output data stored in each of the (N-1) frame buffers and the line buffer in a frame order.

16. The device of claim 10, wherein the image sensor includes a plurality of pixels, and
wherein the plurality of pixels include digital pixels.

17. An operating method of an image sensor, the operating method comprising:
outputting N pieces of frame data corresponding to a first frame to an N^{th} frame from an image sensor;
storing (N-1) pieces of frame data among the N pieces of frame data in a frame buffer; and
storing, in a line buffer, at least a portion of the N pieces of frame data not stored in the frame buffer.

18. The operating method of claim 17, wherein the outputting the N pieces of frame data comprises:
outputting output cycles of the (N-1) pieces of frame data among the N pieces of frame data as a first cycle; and
outputting an output cycle of data of the N^{th} frame among the N pieces of frame data as a second cycle.

19. The operating method of claim 18, wherein the first cycle is faster than the second cycle.

20. The operating method of claim 18, wherein the first cycle is 1/N of the second cycle.
